(19) United States
(12) Patent Application Publication
(10) Pub. No.: US 2026/0265865 A1
(43) Pub. Date: Sep. 10, 2026

(54) NOVEL SEPARATION METHODS

(71) Applicant: THE TRUSTEES OF THE UNIVERSITY OF PENNSYLVANIA, Philadelphia, PA (US)

(72) Inventors: Eric J. SCHELTER, Philadelphia, PA (US); Alexander B. WEBERG, Santa Fe, NM (US); Boyang ZHANG, Philadelphia, PA (US)

(21) Appl. No.: 19/164,822

(22) PCT Filed: Mar. 15, 2024
(86) PCT No.: PCT/US2024/020243

§ 371 Date: Sep. 12, 2025

Related U.S. Application Data
(60) Provisional application No. 63/490,388, filed on Mar. 15, 2023.

(51) Int. Cl. C22B 3/00; C22B 3/44

(52) U.S. Cl. CPC C22B 23/0492; C22B 3/44

(57) ABSTRACT

Described herein is a method for separation of cobalt and nickel complexes that uses simple and non-toxic reagents and reaction schemes to selectively precipitate cobalt.

### CROSS REFERENCE TO RELATED APPLICATIONS

This application claims priority to and the benefit of U.S. Provisional Patent Application No. 63/490,388 (filed Mar. 15, 2023), which is incorporated by reference herein in its entirety for any and all purposes.

### STATEMENT OF GOVERNMENT SUPPORT

This invention was made with government support under CHE-1925708 awarded by the National Science Foundation. The government has certain rights in the invention.

### TECHNICAL FIELD

The disclosure is directed to novel methods of separating critical metals such as cobalt and nickel using simplified techniques.

### BACKGROUND

Cobalt and nickel are critical metals used in various applications in technology. Cobalt is especially important in materials used to produce lithium ion batteries, e.g., cathode materials including LiCoO₂, LiCoₓNi₍₁₋ₓ₎O₂, and others. Cobalt occurs naturally in ores mixed with nickel. Industrial production of the elements always includes a hydrometallurgical separations step. The separations step is typically accomplished using solvent extraction, e.g., kerosene and Cyanex272. However, solvent extraction processes suffer from drawbacks, such as the systems used for solvent extraction being slow, energy-intensive, solvent intensive as well as the waste generated by solvent extraction processes.

There is thus a need in the art for processes that separate critical metals, such as cobalt and nickel, that can be run at scale and enable production of purified cobalt from ores more efficiently. Such techniques are envisioned to be applicable to the recycling of lithium-ion batteries.

### SUMMARY OF THE INVENTION

The disclosure is directed to a process that uses simple, inexpensive reagents to separate cobalt and nickel by precipitating cobalt salts with high selectivity. Without wishing to be bound by any particular theory, it is believed that the process described herein takes advantage of selective chemical interactions in the secondary coordination sphere of cobalt, specifically the hydrogen bonding interaction with protons of an ammonia ligand bound to the metal cations, to crystallize and precipitate a cobalt salt selectively.

The disclosure is directed to a process for efficient, low cost, environmentally friendly separation of cobalt and nickel.

In an aspect, the disclosure is directed to a method of separating cobalt and nickel, comprising: a) mixing a solution comprising a Co^{II} complex and a Ni^{II} complex with an oxidizing agent and a compound selected from a halide, a nitrate, a chlorate, a perchlorate and combinations thereof so as to give rise to a Co^{III} complex; and b) precipitating the Co^{III} complex by contacting the Co^{III} complex with a carbonate, a phosphate, a borate, a sulfate, a silicate or an iodate. In an aspect, the Co^{III} complex is selectively precipitated out of solution.

In an aspect, the oxidizing agent is oxygen or a peroxide such as hydrogen peroxide. In an aspect, the compound is a chloride; ammonium chloride is particularly suitable. In an aspect, the carbonate is sodium carbonate or guanidinium carbonate.

### BRIEF DESCRIPTION OF THE DRAWINGS

The present application is further understood when read in conjunction with the appended drawings. For the purpose of illustrating the subject matter, there are shown in the drawings exemplary embodiments of the subject matter; however, while each represents an embodiment of the present disclosure, the presently disclosed subject matter is not limited to the specific methods, devices, and systems disclosed. In addition, the drawings are not necessarily drawn to scale. In the drawings:

FIG. 1 depicts a simplified schematic of the hydrometallurgical process for laterite ores.

FIG. 2 depicts an overall scheme for selective precipitation of [Co(NH₃)₆][Cl]₃ using carbonate.

FIG. 3 depicts UV-Visible spectra for an ammoniacal solution of mixtures of [Co(NH₃)₆][Cl]₃ (5 mM) and [Ni(NH₃)₆][Cl]₂ (50 mM) before and after addition of sodium carbonate.

FIG. 4 depicts the solid-state structure via X-ray diffractometry of single crystals of precipitated [Co(NH₃)₆][CO₃][Cl] emphasizing hydrogen bonding interactions with the unit cell.

FIG. 5 depicts UV-Vis spectra of the reaction mixture at 1, 2 and 3 hours of aeration for the relative concentrations of [Co(NH₃)₆][Cl]₃ and [Ni(NH₃)₆][Cl]₂.

FIG. 6A depicts the powder X-ray diffraction (PXRD) pattern of precipitated [Co(NH₃)₆][Cl]₃.

FIG. 6B depicts the PXRD pattern of [Co(NH₃)₆][Cl]₃ simulated from the single crystal data of FIG. 4.

FIG. 7 depicts the mother liquor before and after carbonate addition in the treatment of [Co(NH₃)₆][Cl]₃ or [Ni(NH₃)₆][Cl]₂ with Na₂CO₃.

FIG. 8 depicts UV-Vis spectra of the [Co(NH₃)₆][Cl]₃ solution (5 mM) before and after carbonate addition in the treatment of [Co(NH₃)₆][Cl]₃ or [Ni(NH₃)₆][Cl]₂ with Na₂CO₃.

FIG. 9 depicts UV-Vis spectra of the [Ni(NH₃)₆][Cl]₂ solution (5 mM) before and after carbonate addition in the treatment of [Co(NH₃)₆][Cl]3 or [Ni(NH₃)₆][Cl]₂ with Na₂CO₃.

FIG. 10A depicts the X-ray crystal structure of [Co(NH₃)₆][CO₃][Cl], with thermal ellipsoids depicted at 30% probability.

FIG. 10B depicts the unit cell of the [Co(NH₃)₆][CO₃][Cl] solid-state structure in a second view. Hydrogen bonding interactions are highlighted with dashed lines. Hydrogen atoms were omitted for clarity.

FIG. 11 depicts a scheme demonstrating the selective precipitation of cobalt from a Co/Ni mixture of hexammine complexes using carbonate.

FIG. 12 depicts a Co/Ni complex mixture before (left) and after (right) treatment with Na₂CO₃.

FIG. 13 depicts UV-Vis spectra of a solution containing 5 mM [Co(NH₃)₆][Cl]₃ and 50 mM [Ni(NH₃)₆][Cl]₂ in aqueous NH₃ before and after the addition of guanidinium carbonate.

FIG. 14 depicts a UV-Vis spectra of the reaction mixture before and after treatment with Na₂CO₃.

FIG. 15 depicts yellow-orange precipitate collected on the fritted glass funnel and the remaining violet filtrate after filtration.

FIG. 16A depicts effects of Na₂CO₃ equivalents on the recoveries of Co and Ni.

FIG. 16B depicts effects of Na₂CO₃ equivalents on the purities of Co and Ni.

FIG. 17 depicts a scheme demonstrating the selective precipitation of cobalt from a Co/Ni mixture of hexammine complexes using phosphate.

FIG. 18 depicts UV-Vis spectra of the [Co(NH₃)₆][Cl]₃ (5 mM) and [Ni(NH₃)₆][Cl]₂ (50 mM) solution before and after the addition of tripotassium phosphate, K₃PO₄.

FIG. 19 depicts the X-ray crystal structure of [Co(NH₃)₆][PO₄]·4H₂O, with thermal ellipsoids depicted at 30% probability. Hydrogen bonding interactions are highlighted with dashed lines.

FIG. 20 depicts UV-Vis spectra of the [Co(NH₃)₆][Cl]₃ (5 mM) and [Ni(NH₃)₆][Cl]₂ (50 mM) solution before and after the addition of sodium perborate tetrahydrate, NaBO₃·4H₂O.

FIG. 21 depicts UV-Vis spectra of the [Co(NH₃)₆][Cl]₃ (5 mM) and [Ni(NH₃)₆][Cl]₂ (50 mM) solution before and after the addition of borax, Na₂B₄O₇·10H₂O.

FIG. 22 depicts UV-Vis spectra of the [Co(NH₃)₆][Cl]₃ (5 mM) and [Ni(NH₃)₆][Cl]₂ (50 mM) solution before and after the addition of potassium persulfate, K₂S₂O₈.

FIG. 23 depicts UV-Vis spectra of the [Co(NH₃)₆][Cl]₃ (5 mM) and [Ni(NH₃)₆][Cl]₂ (50 mM) solution before and after the addition of sodium thiosulfate pentahydrate, Na₂S₂O₃·5H₂O.

FIG. 24 depicts UV-Vis spectra of the [Co(NH₃)₆][Cl]₃ (5 mM) and [Ni(NH₃)₆][Cl]₂ (50 mM) solution before and after the addition of sodium metasilicate nonahydrate, Na₂SiO₃·9H₂O.

FIG. 25 depicts UV-Vis spectra of the [Co(NH₃)₆][Cl]₃ (5 mM) and [Ni(NH₃)₆][Cl]₂ (50 mM) solution before and after the addition of sodium iodate, NaIO₃.

FIG. 26 depicts UV-Vis spectra of the [Co(NH₃)₆][Cl]₃ (5 mM) and [Ni(NH₃)₆][Cl]₂ (50 mM) solution before and after the addition of sodium metaperiodate, NaIO₄.

### DETAILED DESCRIPTION OF ILLUSTRATIVE EMBODIMENTS

The disclosure may be more fully appreciated by reference to the following description, including the following definitions and examples. Certain features of the disclosed compositions and methods which are described herein in the context of separate aspects, may also be provided in combination in a single aspect. Alternatively, various features of the disclosed compositions and methods that are, for brevity, described in the context of a single aspect, may also be provided separately or in any sub-combination.

Described herein is a new, simple method for easily and efficiently separating cobalt and nickel, a necessary step in both the process for obtaining purified cobalt and nickel from nickel laterite ores (a major source of both cobalt and nickel) and the process for recycling lithium-ion batteries. The process employs prevalent and inexpensive reagents (e.g., ammonium hydroxide, ammonium chloride, sodium carbonate, hydrogen peroxide), is performed in aqueous media, and uses mild conditions (heating to 60° C.). The process relies on the formation of well-defined coordination chemistry compounds of the formula [M(NH₃)₆]ⁿ⁺ (M=Co, Ni, n=2, 3), which, depending on the identity of the metal, will either engage in secondary interactions (hydrogen bonding and/or electrostatic anion-cation interactions) with carbonate (CO₃²⁻), phosphate (PO₄³⁻), borate, sulfate, silicate or iodate to precipitate as a pure network solid, or remain in solution, thereby allowing for Co/Ni separation.

In the present invention, the ammonia ligands remain bound to both metals throughout the entire process. The stronger binding of the ammonia ligands to Co results in greater acidity of the ammonia N—H bonds, which in turn allows for stronger intermolecular hydrogen bonding with CO₃²⁻, (PO₄²⁻), borate, sulfate, silicate or iodate. This hydrogen bonding between [Co(NH₃)]³⁺ and these anions results in the formation of a solid, of the formula [Co(NH₃)][CO₃][Cl], or without being bound to any particular theory or embodiment, [Co(NH₃)][PO₄] in the case of phosphate, which precipitates from solution. The weaker hydrogen bonding capabilities of [Ni(NH₃)]²⁺ precludes the formation of the analogous Ni-based network solid, thereby allowing for an efficient Co/Ni separation.

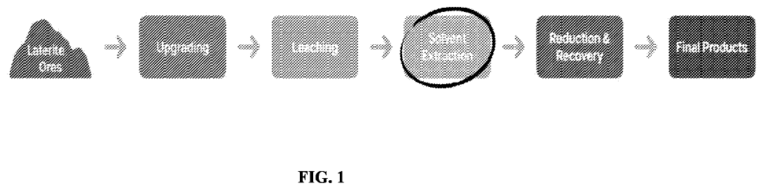

The cobalt and nickel starting materials described herein act as a model for cobalt and nickel containing minerals. The process for extracting such minerals is shown in FIG. 1. The method described herein aims to replace the solvent extraction step shown in FIG. 1.

In some embodiments, the disclosure is directed to a method of separating cobalt and nickel, comprising:
a) mixing a solution comprising a Co^{II} complex and a Ni^{II} complex with an oxidizing agent and a compound selected from a halide, a nitrate, a chlorate, a perchlorate and combinations thereof so as to give rise to a Co^{III} complex; and
b) precipitating the Co^{III} complex by contacting the Cori complex with a carbonate.

In some embodiments, the disclosure is directed to a method of separating cobalt and nickel, comprising:
a) mixing a solution comprising a Co^{II} complex and a Ni^{II} complex with an oxidizing agent and a compound selected from a halide, a nitrate, a chlorate, a perchlorate and combinations thereof so as to give rise to a Co^{III} complex; and
b) precipitating the Co^{III}, complex by contacting the Co^{III} complex with a phosphate.

In some embodiments, the disclosure is directed to a method of separating cobalt and nickel, comprising:
a) mixing a solution comprising a Co^{II} complex and a Ni^{II} complex with an oxidizing agent and a compound selected from a halide, a nitrate, a chlorate, a perchlorate and combinations thereof so as to give rise to a Co^{III} complex; and
b) precipitating the Cori complex by contacting the Co^{III} complex with a borate.

In some embodiments, the disclosure is directed to a method of separating cobalt and nickel, comprising:
a) mixing a solution comprising a Co^{II} complex and a Ni^{II} complex with an oxidizing agent and a compound selected from a halide, a nitrate, a chlorate, a perchlorate and combinations thereof so as to give rise to a Co^{III} complex; and
b) precipitating the Co^{III} complex by contacting the Co^{III} complex with a sulfate.

In some embodiments, the disclosure is directed to a method of separating cobalt and nickel, comprising:
a) mixing a solution comprising a Co^{II} complex and a Ni^{II} complex with an oxidizing agent and a compound selected from a halide, a nitrate, a chlorate, a perchlorate and combinations thereof so as to give rise to a Co^{III} complex; and
b) precipitating the Co^{III} complex by contacting the Co^{III} complex with a silicate.

In some embodiments, the disclosure is directed to a method of separating cobalt and nickel, comprising:
a) mixing a solution comprising a Co^{II} complex and a Ni^{II} complex with an oxidizing agent and a compound selected from a halide, a nitrate, a chlorate, a perchlorate and combinations thereof so as to give rise to a Co^{III} complex; and
b) precipitating the Co^{III} complex by contacting the Co^{III} complex with an iodate.

In some embodiments, the oxidizing agent is a peroxide, oxygen, or a mixture thereof. In some embodiments, the oxidizing agent is a peroxide. In some embodiments, the peroxide is hydrogen peroxide. In some embodiments, the oxidizing agent is oxygen. In some embodiments, the oxidizing agent is mixture of a peroxide and oxygen.

In some embodiments, the compound is a halide. In some embodiments, the halide is a chloride. In some embodiments, the chloride is selected from sodium chloride, potassium chloride, calcium chloride, ammonium chloride and combinations thereof. In some embodiments, the chloride is ammonium chloride.

In some embodiments, the compound is a nitrate. In some embodiments, the nitrate is selected from ammonium nitrate, calcium nitrate, sodium nitrate, potassium nitrate and combinations thereof.

In some embodiments, the compound is a chlorate. In some embodiments, the chlorate is selected from ammonium chlorate, sodium chlorate, magnesium chlorate, potassium chlorate, calcium chlorate and combinations thereof.

In some embodiments, the compound is a perchlorate. In some embodiments, the perchlorate is selected from ammonium perchlorate, sodium perchlorate, potassium perchlorate and combinations thereof.

In some embodiments, the Co^{II} complex is CoCl₂*6H₂O. In some embodiments, the Ni^{II} complex is NiCl₂*6H₂O. In some embodiments, the Co^{II} complex is a chloride salt. In some embodiments, the Ni^{II} complex is a chloride salt.

In some embodiments, step a) further comprises mixing with ammonium chloride in aqueous ammonium hydroxide solution. In some embodiments, the mixing is carried out at about 0° C. and the solution is then heated to about 60° C. In some embodiments, the mixing is carried out at room temperature and the solution is then heated to about 60° C.

In some embodiments, the solution is heated from about 0° C. to about 100° C. In some embodiments, the solution is heated from about 0° C. to about 90° C. In some embodiments, the solution is heated from about 0° C. to about 80° C. In some embodiments, the solution is heated from about 0° C. to about 70° C. In some embodiments, the solution is heated from about 0° C. to about 60° C. In some embodiments, the solution is heated from about 0° C. to about 50° C. In some embodiments, the solution is heated from about 0° C. to about 40° C. In some embodiments, the solution is heated from about 0° C. and to about 30° C. In some embodiments, the solution is heated from about 0° C. to about 20° C.

In some embodiments, the solution is heated from room temperature to about 100° C. In some embodiments, the solution is heated from room temperature to about 90° C. In some embodiments, the solution is heated from room temperature to about 80° C. In some embodiments, the solution is heated from room temperature to about 70° C. In some embodiments, the solution is heated from room temperature to about 60° C. In some embodiments, the solution is heated from room temperature to about 50° C. In some embodiments, the solution is heated from room temperature to about 40 C. In some embodiments, the solution is heated from room temperature and to about 30° C.

In some embodiments, the mixing is carried out for at least about 10 minutes at about 0° C. In some embodiments, the mixing is carried out for at least about 20 minutes at about 0° C. In some embodiments, the mixing is carried out for at least about 30 minutes at about 0° C. In some embodiments, the mixing is carried out for at least about 40 minutes at about 0° C. In some embodiments, the mixing is carried out for at least about 50 minutes at about 0° C. In some embodiments, the mixing is carried out for at least about 60 minutes at about 0° C.

In some embodiments, the mixing is carried out for at least about 10 minutes at about 10° C. In some embodiments, the mixing is carried out for at least about 20 minutes at about 10° C. In some embodiments, the mixing is carried out for at least about 30 minutes at about 10° C. In some embodiments, the mixing is carried out for at least about 40 minutes at about 10° C. In some embodiments, the mixing is carried out for at least about 50 minutes at about 10° C. In some embodiments, the mixing is carried out for at least about 60 minutes at about 10° C.

In some embodiments, the mixing is carried out for at least about 10 minutes at about 20° C. In some embodiments, the mixing is carried out for at least about 20 minutes at about 20° C. In some embodiments, the mixing is carried out for at least about 30 minutes at about 20° C. In some embodiments, the mixing is carried out for at least about 40 minutes at about 20° C. In some embodiments, the mixing is carried out for at least about 50 minutes at about 20° C. In some embodiments, the mixing is carried out for at least about 60 minutes at about 20° C.

In some embodiments, the mixing is carried out for at least about 10 minutes at about 30° C. In some embodiments, the mixing is carried out for at least about 20 minutes at about 30° C. In some embodiments, the mixing is carried out for at least about 30 minutes at about 30° C. In some embodiments, the mixing is carried out for at least about 40 minutes at about 30° C. In some embodiments, the mixing is carried out for at least about 50 minutes at about 30° C. In some embodiments, the mixing is carried out for at least about 60 minutes at about 30° C.

In some embodiments, the mixing is carried out for at least about 10 minutes at about 40° C. In some embodiments, the mixing is carried out for at least about 20 minutes at about 40° C. In some embodiments, the mixing is carried out for at least about 30 minutes at about 40° C. In some embodiments, the mixing is carried out for at least about 40 minutes at about 40° C. In some embodiments, the mixing is carried out for at least about 50 minutes at about 40° C. In some embodiments, the mixing is carried out for at least about 60 minutes at about 40° C.

In some embodiments, the mixing is carried out for at least about 10 minutes at about 50° C. In some embodiments, the mixing is carried out for at least about 20 minutes at about 50° C. In some embodiments, the mixing is carried out for at least about 30 minutes at about 50° C. In some embodiments, the mixing is carried out for at least about 40 minutes at about 50° C. In some embodiments, the mixing is carried out for at least about 50 minutes at about 50° C. In some embodiments, the mixing is carried out for at least about 60 minutes at about 50° C.

In some embodiments, the mixing is carried out for at least about 10 minutes at about 60° C. In some embodiments, the mixing is carried out for at least about 20 minutes at about 60° C. In some embodiments, the mixing is carried out for at least about 30 minutes at about 60° C. In some embodiments, the mixing is carried out for at least about 40 minutes at about 60° C. In some embodiments, the mixing is carried out for at least about 50 minutes at about 60° C. In some embodiments, the mixing is carried out for at least about 60 minutes at about 60° C.

In some embodiments, the mixing is carried out for at least about 10 minutes at about 70° C. In some embodiments, the mixing is carried out for at least about 20 minutes at about 70° C. In some embodiments, the mixing is carried out for at least about 30 minutes at about 70° C. In some embodiments, the mixing is carried out for at least about 40 minutes at about 70° C. In some embodiments, the mixing is carried out for at least about 50 minutes at about 70° C. In some embodiments, the mixing is carried out for at least about 60 minutes at about 70° C.

In some embodiments, step a) produces [Co(NH₃)₆][Cl]₃. In some embodiments, step a) produces [Ni(NH₃)₆][Cl]₂.

In some embodiments, step a) oxidizes the Co^{II} complex to a Co^{III} complex. In some embodiments, the Co^{III} complex is [Co(NH₃)₆][Cl]₃.

In some embodiments, the carbonate is sodium carbonate, sodium bicarbonate or guanidinium carbonate. In some embodiments, the carbonate is sodium carbonate. In some embodiments, the carbonate is sodium bicarbonate. In some embodiments, the carbonate is guanidinium carbonate.

In some embodiments, the phosphate is sodium phosphate or potassium phosphate. In some embodiments, the phosphate is sodium phosphate. In some embodiments, the phosphate is potassium phosphate. In some embodiments, the phosphate is tripotassium phosphate. In some embodiments, the phosphate is dipotassium phosphate. In some embodiments, the phosphate is monopotassium phosphate. In some embodiments, the phosphate is trisodium phosphate. In some embodiments, the phosphate is disodium phosphate. In some embodiments, the phosphate is monosodium phosphate.

In some embodiments, the borate is borax, Na₂B₄O₇·10H₂O, or sodium perborate Na₂([B₂O₄(OH)₄]). In some embodiments, the borate is sodium perborate. In some embodiments, the borate is borax.

In some embodiments, the sulfate is potassium persulfate, Na₂S₂O₈, ammonium persulfate, (NH₄)₂S₂O₈, or sodium thiosulfate, Na₂S₂O₃·5H₂O. In some embodiments, the sulfate is potassium persulfate. In some embodiments, the sulfate is ammonium persulfate. In some embodiments, the sulfate is sodium thiosulfate.

In some embodiments, the silicate is sodium metasilicate nonahydrate, Na₂SiO₃·9H₂O.

In some embodiments, the iodate is sodium iodate, NaIO₃, or sodium metaperiodate, NaIO₄. In some embodiments, the iodate is sodium iodate. In some embodiments, the iodate is sodium metaperiodate.

In some embodiments, the carbonate, phosphate, borate, sulfate, silicate or iodate is included in an amount that is at least about 1 equivalent of carbonate, phosphate, borate, sulfate, silicate or iodate per cobalt. In some embodiments, the carbonate, phosphate, borate, sulfate, silicate or iodate is included in an amount that is at least about 2 equivalents of carbonate, phosphate, borate, sulfate, silicate or iodate per cobalt. In some embodiments, the carbonate, phosphate, borate, sulfate, silicate or iodate is included in an amount that is at least about 3 equivalents of carbonate, phosphate, borate, sulfate, silicate or iodate per cobalt. In some embodiments, the carbonate, phosphate, borate, sulfate, silicate or iodate is included in an amount that is at least about 4 equivalents of carbonate, phosphate, borate, sulfate, silicate or iodate per cobalt. In some embodiments, the carbonate, phosphate, borate, sulfate, silicate or iodate is included in an amount that is at least about 5 equivalents of carbonate, phosphate, borate, sulfate, silicate or iodate per cobalt. In some embodiments, the carbonate, phosphate, borate, sulfate, silicate or iodate is included in an amount that is at least about 6 equivalents of carbonate, phosphate, borate, sulfate, silicate or iodate per cobalt. In some embodiments, the carbonate, phosphate, borate, sulfate, silicate or iodate is included in an amount that is at least about 7 equivalents of carbonate, phosphate, borate, sulfate, silicate or iodate per cobalt. In some embodiments, the carbonate, phosphate, borate, sulfate, silicate or iodate is included in an amount that is at least about 8 equivalents of carbonate, phosphate, borate, sulfate, silicate or iodate per cobalt. In some embodiments, the carbonate, phosphate, borate, sulfate, silicate or iodate is included in an amount that is at least about 9 equivalents of carbonate or phosphate per cobalt. In some embodiments, the carbonate, phosphate, borate, sulfate, silicate or iodate is included in an amount that is at least about 10 equivalents of carbonate, phosphate, borate, sulfate, silicate or iodate per cobalt. In some embodiments, the carbonate, phosphate, borate, sulfate, silicate or iodate is included in an amount up to about 10 equivalents of carbonate, phosphate, borate, sulfate, silicate or iodate per cobalt.

In some embodiments, the carbonate, phosphate, borate, sulfate, silicate or iodate is comprised in an aqueous ammonium hydroxide solution.

In some embodiments, step b) is carried out at room temperature for about 10 minutes. In some embodiments, step b) is carried out at room temperature for about 20 minutes. In some embodiments, step b) is carried out at room temperature for about 30 minutes. In some embodiments, step b) is carried out at room temperature for about 40 minutes. In some embodiments, step b) is carried out at room temperature for about 50 minutes. In some embodiments, step b) is carried out at room temperature for about 60 minutes.

In some embodiments, the disclosure is directed to a method of recycling cobalt from cathode materials of a lithium ion battery, comprising:
a) mixing a solution comprising a mixed metal oxide comprising cobalt and nickel with an oxidizing agent and a compound selected from a halide, a nitrate, a chlorate, a perchlorate and combinations thereof, and
b) precipitating the cobalt from the solution by contacting with a carbonate.

In some embodiments, the disclosure is directed to a method of recycling cobalt from cathode materials of a lithium ion battery, comprising:
a) mixing a solution comprising a mixed metal oxide comprising cobalt and nickel with an oxidizing agent and a compound selected from a halide, a nitrate, a chlorate, a perchlorate and combinations thereof; and
b) precipitating the cobalt from the solution by contacting with a phosphate.

In some embodiments, the disclosure is directed to a method of recycling cobalt from cathode materials of a lithium ion battery, comprising:
a) mixing a solution comprising a mixed metal oxide comprising cobalt and nickel with an oxidizing agent and a compound selected from a halide, a nitrate, a chlorate, a perchlorate and combinations thereof; and
b) precipitating the cobalt from the solution by contacting with a borate.

In some embodiments, the disclosure is directed to a method of recycling cobalt from cathode materials of a lithium ion battery, comprising:
a) mixing a solution comprising a mixed metal oxide comprising cobalt and nickel with an oxidizing agent and a compound selected from a halide, a nitrate, a chlorate, a perchlorate and combinations thereof; and
b) precipitating the cobalt from the solution by contacting with a sulfate.

In some embodiments, the disclosure is directed to a method of recycling cobalt from cathode materials of a lithium ion battery, comprising:
a) mixing a solution comprising a mixed metal oxide comprising cobalt and nickel with an oxidizing agent and a compound selected from a halide, a nitrate, a chlorate, a perchlorate and combinations thereof; and
b) precipitating the cobalt from the solution by contacting with a silicate.

In some embodiments, the disclosure is directed to a method of recycling cobalt from cathode materials of a lithium ion battery, comprising:
a) mixing a solution comprising a mixed metal oxide comprising cobalt and nickel with an oxidizing agent and a compound selected from a halide, a nitrate, a chlorate, a perchlorate and combinations thereof; and
b) precipitating the cobalt from the solution by contacting with an iodate.

In some embodiments, the mixed metal oxide comprising cobalt and nickel is obtained from the cathode material of a lithium ion battery. In some embodiments, the mixed metal oxide comprising cobalt and nickel is lithium nickel cobalt manganese oxide (LiNiCoMnO₂), lithium nickel manganese spinel (LiNi_{0.5}Mn_{1.5}O₄) or lithium nickel cobalt aluminium oxide (LiNiCoAlO₂). In some embodiments, the mixed metal oxide comprising cobalt and nickel is of the formula LiCoₓNi₍₁₋ₓ₎O₂.

The following Examples are provided to illustrate some of the concepts described within this disclosure. While the Examples are considered to provide an embodiment, it should not be considered to limit the more general embodiments described herein.

### EXAMPLES

### General Experimental Methods

### ICP-OES: Sample Preparation

Aliquots and portions were taken from the isolated filtrate and precipitate respectively, and aqueous aliquots were dried under vacuum prior to next steps. All samples were heated at 300° C. in a sand bath for 30 minutes and cooled to room temperature. Finally, samples were digested in 5 mL of concentrated HCl at room temperature for at least an hour, followed by dilution with ultra-pure water.

### ICP-OES: Instrumentation

A Spectro Genesis ICP-OES spectrometer equipped with Modified Lichte nebulizer chamber and 2.5 mm torch injector was employed to evaluate the Co and Ni concentrations in the separated products. Standard solutions for calibrations were prepared by performing dilutions of 1000 μg/mL cobalt and nickel plasma standard solutions. A range of 9 standard solutions (ca. 200-0.05 ppm Co and Ni) and a blank solution (ultra-pure water) were prepared freshly before each set of measurements. All standards calibration curves passed the regression fit with R²>0.999. Emission wavelengths chosen for analyses were Co 230.786 nm and Ni 221.648 nm.

### Example 1—Separation of Nickel and Cobalt with Hydrogen Peroxide as Oxidizer

In Situ Generation of [Co(NHs)₆][Cl]₃ and [Ni(NH₃)₆][Cl]₂

CoCl₂·6H₂O (0.333 g, 1.40 mmol, 1.1 equivalents), NiCl₂·6H₂O (3.302 g, 13.9 mmol, 11 equivalents) were dissolved in 5 mL deionized water. The mixture was sonicated until the metal salts dissolved completely to form a dark green solution. An aliquot of the solution (9.26 wt %≈ 1/11) was collected and set aside for subsequent ICP analysis as starting mixture. To the remaining solution was added NH₄Cl (2.024 g, 37.8 mmol, 30 equivalents) and activated charcoal (0.167 g, 13.9 mmol, 11 equivalents), followed by dropwise addition of 20 mL of aqueous NH₃ (28-30%) which led to an immediate color change to violet.

In an ice bath, to the flask was slowly added 15 mL of cold 30% H₂O₂ was added dropwise over ca. 2 minutes with stirring. An exothermic reaction with effervescence immediately occurred. The mixture was stirred (200 rpm) at 0° C. for 20 minutes and then at room temperature for 20 minutes.

Following oxidation, the mixture was then heated to 60° C. in a water bath with stirring for 20 minutes, and the charcoal was removed by filtering the hot solution over a Buchner funnel. The filtered charcoal was washed with 3×5 mL of aqueous NH₃ which was combined with dark magenta filtrate. An additional 150 mL of aqueous NH₃ was immediately added to the filtrate.

Formation of [Co(NHs)₆][CO₃][Cl]

Sodium carbonate (0.401 g, 3.78 mmol, 4 equivalents) was added to the filtered reaction mixture the dark magenta filtrate. Upon stirring (650 rpm) for 20 minutes at room temperature, a yellow-orange precipitate gradually formed. The solid was collected by filtering the slurry over a medium porosity fritted funnel and was subsequently washed with 3×3 mL cold aqueous NH₃. The precipitate was dried at 40° C. in an electric oven overnight before being removed from the funnel. The results from triplicated trials are shown below in Table 1.

TABLE 1
ICP-OES Analysis of Co/Ni Separation (H₂O₂ as Oxidizer)

| | |
|---|---|
| Precipitate | Filtrate |

| | % Co | % Co | % Ni | % Ni |
|---|---|---|---|---|
| Trial | Recovery | Purity | Recovery | Purity |
| 1 | 78.4 | 99.5 | 108.3 | 98.1 |
| 2 | 75.9 | 99.1 | 102.1 | 98.0 |
| 3 | 85.3 | 99.4 | 102.5 | 98.1 |
| Average | 79.8 | 99.3 | 104.3 | 98.1 |
| Standard | 4.9 | 0.2 | 3.4 | 0.1 |
| Deviation | | | | |

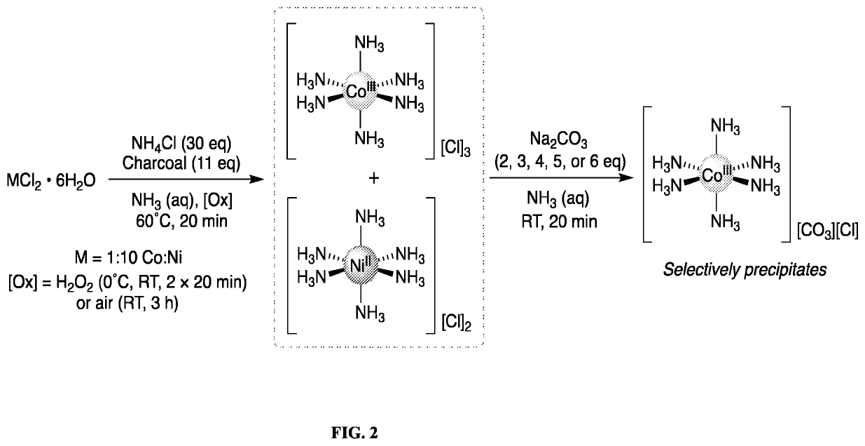

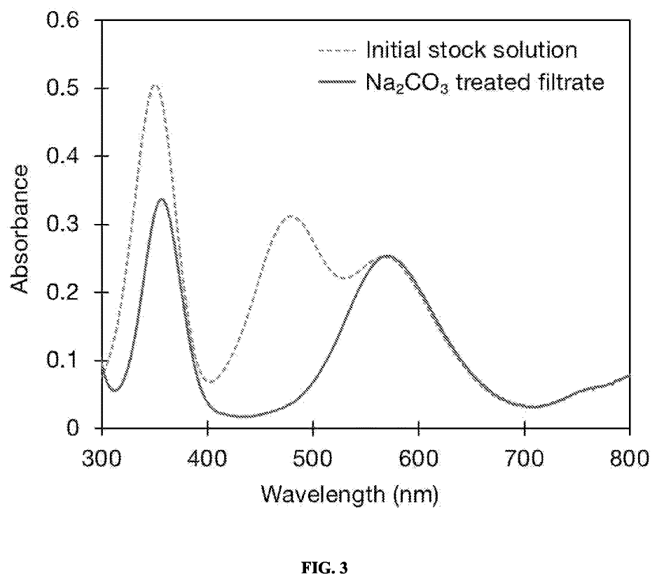

An overall scheme for selective precipitation of cobalt using carbonate is shown in FIG. 2. Evidence of selective cobalt precipitation by carbonate addition is demonstrated by UV-Vis spectrometry, as shown in FIG. 3.

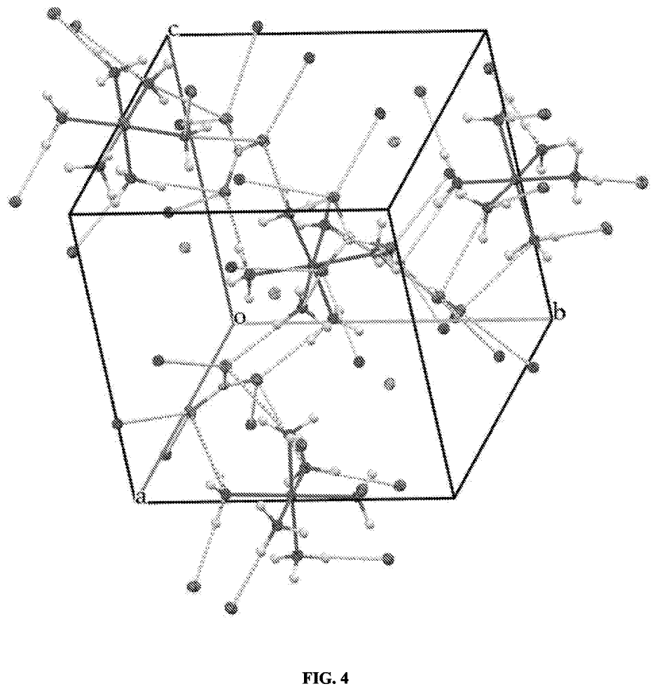

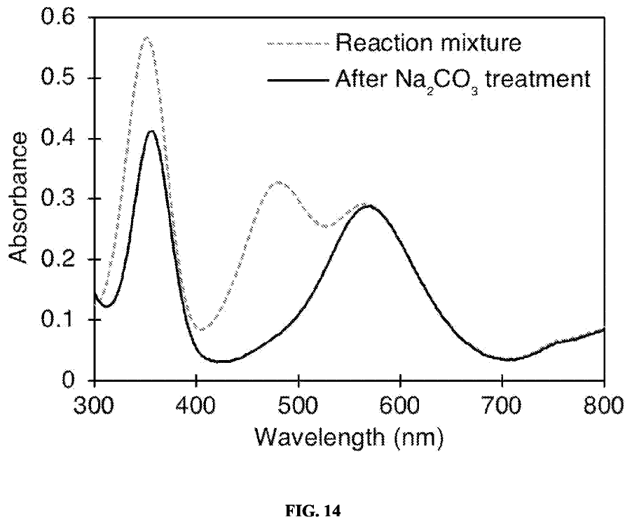

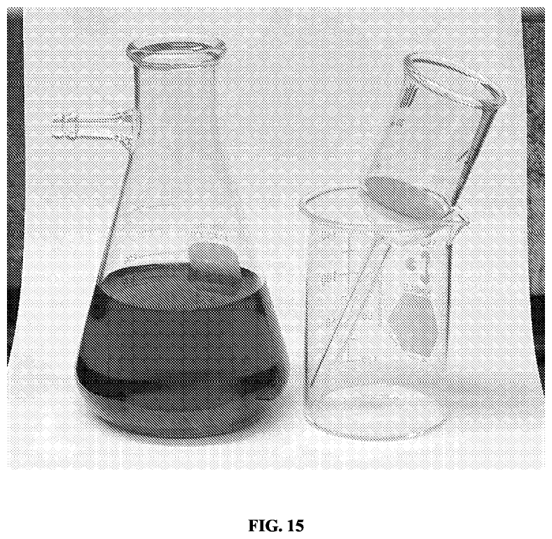

Powder X-ray diffraction pattern was obtained for the isolated yellow-orange precipitate, and it matches that of the characterized solid, [Co(NH₃)₆][CO₃][Cl], as shown in FIG. 4. The remaining blue-violet filtrate showed prominent spectral features corresponding to [Ni(NH₃)₆][Cl]₂ and the absence of the characteristic [Co(NH₃)₆][Cl]₃ feature at 480 nm via UV-Vis analysis (FIG. 14).

### Example 2—Separation of Nickel and Cobalt with Oxygen as Oxidizer

Cobalt and nickel starting materials were subjected to substantially the same conditions as in Example 1, except that oxygen was used as the oxidizing agent.

The reaction utilized aeration, where a glass pipette was submerged in the solution to pass air through the mixture for 3 hours. An additional 40 mL of NH₃ (aq) was added to mixture before aeration started.

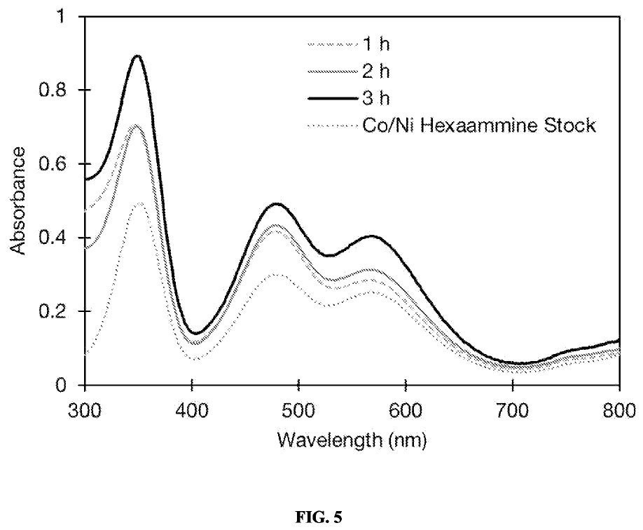

The reaction mixture during aeration was monitored by UV-Vis spectroscopy at 1-, 2-, and 3-hour marks (FIG. 5). As shown, [Co(NH₃)₆]³⁺ features (λ=476 nm) are present at 1 hour of aeration. Results from triplicated experiments are shown in Table 2.

TABLE 2
ICP-OES Analysis of Co/Ni Separation (Oxygen as Oxidizer)

| | |
|---|---|
| Precipitate | Filtrate |

| | % Co | % Co | % Ni | % Ni |
|---|---|---|---|---|
| Trial | Recovery | Purity | Recovery | Purity |
| 1 | 82.2 | 96.7 | 98.0 | 99.3 |
| 2 | 81.0 | 97.1 | 97.2 | 99.3 |
| 3 | 81.4 | 96.7 | 95.9 | 99.4 |
| Average | 81.5 | 96.8 | 97.0 | 99.3 |
| Standard | 0.6 | 0.3 | 1.1 | 0.1 |
| Deviation | | | | |

### Example 3—Separation of Nickel and Cobalt with Combination of Hydrogen Peroxide and Oxygen as Oxidizer

Cobalt and nickel starting materials were subjected to substantially the same conditions as in Example 1, except that a combination of H₂O₂ and oxygen was used as the oxidizing agent.

The reaction utilized aeration, where a glass pipette was submerged in the solution to pass air through the mixture for 3 hours. Then, 5 mL of H₂O₂ was added and the reaction was stirred at room temperature for 15 minutes. Finally, the reaction was stirred for 20 minutes at 60° C.

The best precipitate yield (compared to theoretical yield) was 74.6%.

### Example 4—Carbonate Concentration and Separation of Nickel and Cobalt

The effects of carbonate concentration were examined using the following experimental protocol.

Stock solutions of Co (5 mM) and Ni (50 mM) hexammine complexes were prepared as described in Example 1. For each trial, 5 mL of stock solution were treated with either ca. 9 mg (3 equivalents per Co) or ca. 23 mg (9 equivalents per Co) of Na₂CO₃. These mixtures were stirred at room temperature for 15 mins. The orange precipitate was filtered onto a frit and washed with NH₃ (aq). The precipitate was removed from the frit by washing through with H₂O. The results are shown below in Table 3 (3 equivalents of carbonate per Co) and Table 4 (9 equivalents of carbonate per Co).

TABLE 3
Separation of Nickel and Cobalt-3 Equivalents of Carbonate

| | Precipitate | | | Filtrate | | | |
|---|---|---|---|---|---|---|---|
| | | % Co | % Co | | % Ni | % Ni | |
| Trial | EF_{Co} | Recovery | Purity | EF_{Ni} | Recovery | Purity | β_{Co/Ni} |
| 1 | 78 | 64 | 98.7 | 236 | 79 | 99.6 | 18,496 |
| 2 | 106 | 81 | 99.1 | 197 | 105 | 99.5 | 20,802 |
| 3 | 149 | 82 | 99.3 | 133 | 100 | 99.3 | 19,816 |
| average | 111 | 76 | 99.0 | 189 | 95 | 99.4 | 19,700 |
| Standard | 36 | 10 | 0.3 | 52 | 14 | 0.2 | 1,200 |
| Deviation | | | | | | | |

TABLE 4
Separation of Nickel and Cobalt-9 Equivalents of Carbonate

| | Precipitate | | | Filtrate | | | |
|---|---|---|---|---|---|---|---|
| | | % Co | % Co | | | % Co | % Co |
| Trial | EF_{Co} | Recovery | Purity | Trial | EF_{Co} | Recovery | Purity |
| 1 | 26 | 86 | 96.3 | 180 | 111 | 99.44 | 4,670 |
| 2 | 77 | 86 | 98.7 | 179 | 107 | 99.44 | 13,726 |
| 3 | 34 | 79 | 97.1 | 187 | 100 | 99.7 | 6,262 |
| Average | 45 | 84 | 97 | 182 | 106 | 99.45 | 8,200 |
| Standard | 27 | 4 | 1 | 4 | 6 | 0.01 | 4,800 |
| Deviation | | | | | | | |

### Example 5—Cobalt Precipitation with Carbonate

### Materials & Methods

The compounds CoCl₂·6H₂O (Thermo Scientific), NiCl₂·6H₂O (Thermo Scientific), NH₄Cl (99.5%, Thermo Scientific), Na₂CO₃ (Fisher Chemical), Gdm₂CO₃ (Acros), activated charcoal (Acros), ammonium hydroxide (28.0-30.0 w/w %, Fisher Chemical), and H₂O₂ (30%, Fisher Chemical) were used as received. Ultra-pure water was generated by a Millipore Milli-Q system.

### Synthesis of [Co(NH₃)₆][Cl]₃

[Co(NH₃)₆][Cl]₃ was prepared using a procedure adapted from the literature (Bjerrum, et. al., 1946). Briefly, CoCl₂·6H₂O (4.5 g, 19 mmol) and NH₄Cl (3.0 g, 56 mmol) were dissolved in water (5 mL) at 60° C. with stirring. The solution was cooled to 0° C., to which activated charcoal (0.25 g, 21 mmol), aqueous NH₃ (20 mL), and cold 30% H₂O₂ (20 mL, dropwise) were added. The mixture was heated to 60° C. with stirring for 20 min and then cooled to 0° C. A black-brown precipitate was obtained upon filtration and was then dissolved in 40 mL of boiling water mixed with 1.5 mL of 12 M HCl. The hot solution was immediately filtered. Upon cooling the red-orange filtrate to 0° C., an orange solid formed and was collected via filtration. The solid was washed with cold water (2 mL) and acetone (3 mL) before drying under vacuum. Yield: 2.7 g, 54%.

### Synthesis of [Ni(NH₃)₆][Cl]₂

NiCl₂·6H₂O (30.0 g, 126 mmol) and NH₄Cl (6.78 g, 126 mmol) were dissolved in water (10 mL). To the green solution was added aqueous NH₃ (150 mL). The mixture immediately turned violet and was stirred at r.t. for 20 min. A violet solid was obtained upon filtration and was then washed with five 5 mL portions of cold aqueous NH₃, followed by three 10 mL portions of diethyl ether. The solid was dried under vacuum for 4 h. Yield: 24.6 g, 84%.

In Situ Generation of the [Co(NH₃)₆][Cl]₃ and [Ni(NH₃)₆][Cl]₂ Mixture

CoCl₂·6H₂O (0.301 g, 1.27 mmol, 1 equivalent), NiCl₂·6H₂O (2.996 g, 12.6 mmol, 10 equivalents) were dissolved in 6 mL of deionized water. The mixture was sonicated until the metal salts dissolved completely to form a dark green solution. NH₄Cl (2.024 g, 37.8 mmol, 30 equivalents) and activated charcoal (0.167 g, 13.9 mmol, 11 equivalents) was subsequently added, followed by dropwise addition of 20 mL of aqueous NH₃ which led to an immediate color change to violet. The mixture was then subjected to oxidation via one of the two methods below.

Method 1: Using H₂O₂. In an ice bath, to the flask was slowly added 20 mL of cold 30% H₂O₂ dropwise over ca. 2 min with stirring (200 rpm). An exothermic reaction with effervescence immediately occurred. The mixture was stirred (200 rpm) at 0° C. for 20 min and then at room temperature for 20 min.

Method 2: Using Aeration. An additional 40 mL of aqueous NH₃ was added to the mixture to compensate for the loss of ammonia due to aeration. A glass pipette was then submerged in the solution to pass air through the mixture for 3 h. The mixture was then heated to 60° C. in a water bath with stirring for 20 min, and the charcoal was removed by filtering the hot solution over a Buchner funnel. An additional 180 mL of aqueous NH₃ was immediately added to the dark magenta filtrate. UV-Vis: λ=476 nm ([Co(NH₃)₆][Cl]₃), λ=571 nm ([Ni(NH₃)₆][Cl]₂).

Separation of [Co(NH₃)₆][CO₃][Cl]

Na₂CO₃ (following Method 1: 0.401 g, 3.78 mmol, 3 equivalents) was added to the dark magenta filtrate containing [Co(NH₃)₆][Cl]₃ and [Ni(NH₃)₆][Cl]₂ from above. Upon stirring at 650 rpm for 20 minutes at room temperature, a yellow-orange precipitate gradually formed. The solid was collected by filtering the slurry over a medium porosity fritted funnel and was subsequently washed with 3×3 mL of aqueous NH₃. The precipitate was dried overnight at 40° C. in an electric oven before being removed from the funnel. Yield: 0.297 g, 83.2%. (% yield=mass of the isolated precipitate/expected mass of [Co(NH₃)₆][CO₃][Cl]).

Selective Precipitation of Co(NH₃)₆³⁺ with Carbonate

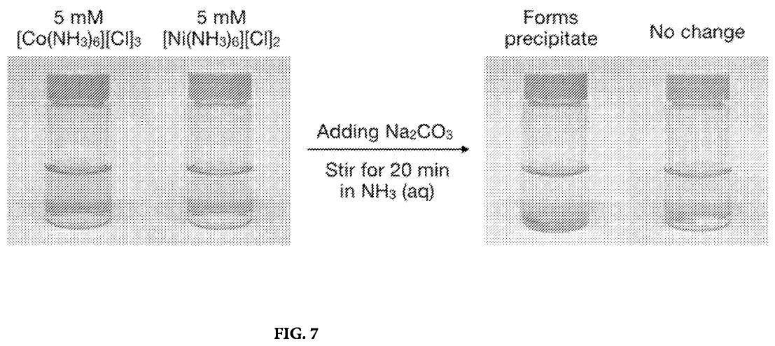

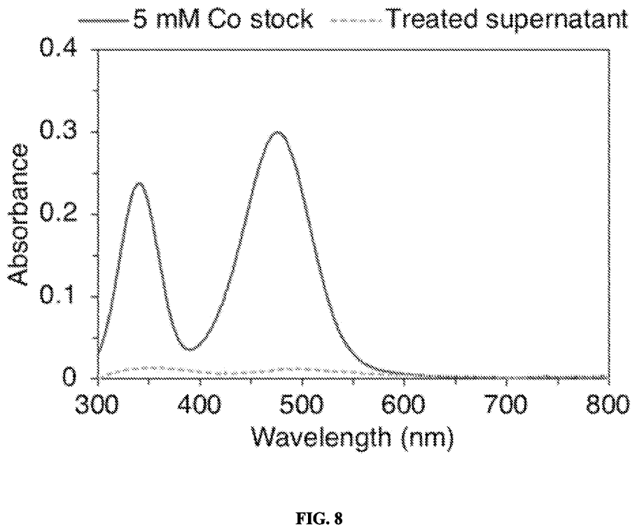

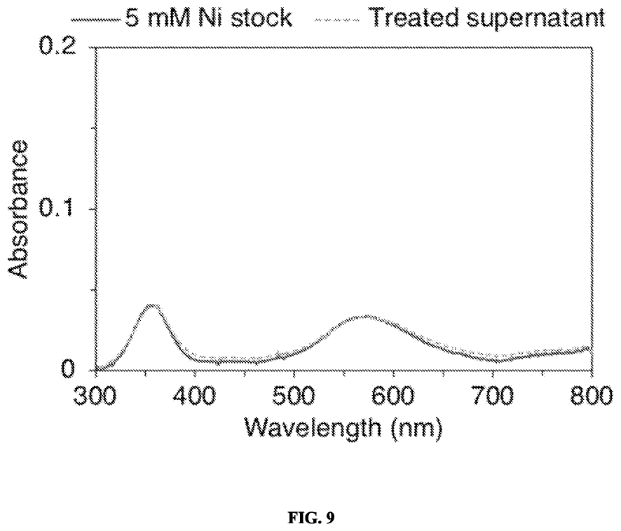

Upon treatment of a solution of the trivalent Co Werner complex ([Co(NH₃)₆][Cl]₃, 5 mM) in concentrated aqueous ammonia with sodium carbonate (Na₂CO₃, 2 equivalents), a yellow-orange precipitate was observed to form, leaving behind a colorless mother liquor (FIG. 7). UV-Vis spectra of the mother liquor before and after Na₂CO₃ addition indicated a quantitative precipitation of the cobalt complex from solution (FIG. 8). Similar results were observed when using either guanidinium carbonate (Gdm₂CO₃) or sodium bicarbonate, indicating that the counter-cations to carbonate are spectator ions in the observed reaction. The precipitate was found to be insoluble in aqueous ammonia, but soluble in neutral water. Intriguingly, when the divalent Ni Werner complex ([Ni(NH₃)₆][Cl]₂, 5 mM) was treated with carbonate under analogous conditions, no precipitation was observed. Additionally, UV-Vis spectral features associated with [Ni(NH₃)₆][Cl]₂ before and after carbonate addition did not change over the course of several days (FIG. 7 and FIG. 9). Experiments using larger quantities of carbonate and more concentrated [Ni(NH₃)₆][Cl]₂ (50 mM) likewise did not result in the formation of insoluble materials. The selectivity of the carbonate-induced precipitation for [Co(NH₃)₆][Cl]₃ over [Ni(NH₃)₆][Cl]₂ is consistent with our hypothesis that stronger ammonia bonding to the trivalent metal should display stronger intermolecular H-bonding interactions, and provided promise for effecting an efficient Co/Ni separation under industrially-relevant conditions.

### Structural Characterization of the Cobalt Precipitate

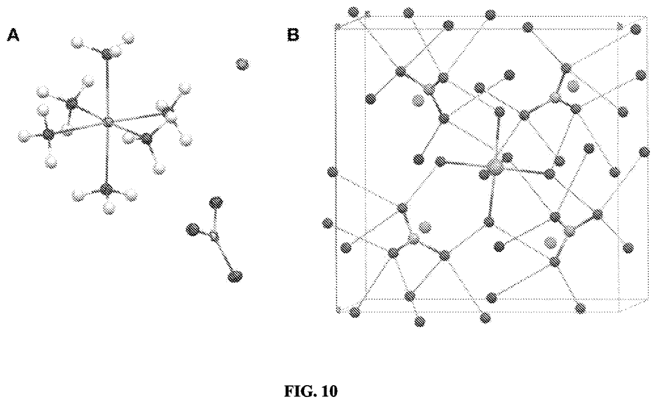

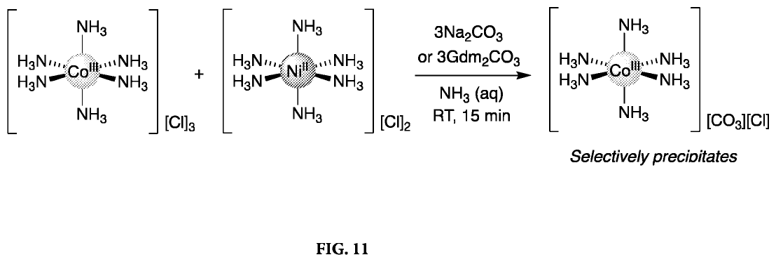

Addition of Na₂CO₃ to [Co(NH₃)₆][Cl]₃ without stirring afforded the formation orange single crystals of X-ray quality. Alternatively, crystals obtained using Gdm₂CO₃ or NaHCO₃ in place of Na₂CO₃ were visually identical and displayed identical cubic unit cells. Elucidation of the solid-state structure of this material revealed the formation of a solid of the formula [Co(NH₃)₆][CO₃][Cl] in which two of the chloride anions in [Co(NH₃)₆][Cl]₃ were exchanged for a single carbonate dianion (FIG. 10A). It should be noted that this structure was recently reported by Forbes and coworkers, although within a different context. Hydrogen bonding between the ammonia ligands and the carbonate anions are prevalent throughout the structure (FIG. 10B), with each [Co(NH₃)₆]³⁺ unit displaying six close contacts with neighboring carbonate anions (average Nₐₘₘₒₙᵢₐ−O_{carbonate} distance=2.87(2) Å) and three slightly longer contacts with neighboring carbonates (Nₐₘₘₒₙᵢₐ−O_{carbonate} distance=3.007(3) Å). Far longer, and presumably weaker, interactions between the chloride ion and [Co(NH₃)₆]³⁺ were observed in the solid-state structure of [Co(NH₃)₆][CO₃][Cl], with an average Nₐₘₘₒₙᵢₐ−Cl distance of 3.42(2) Å. The H-bonding throughout the structure likely contributes the precipitation of this material and suggests that analogous H-bonding/anion-cation interactions in the Ni Werner complex are far weaker. Without wishing to be bound to any particular theory, it is hypothesized that the apparent selectivity of the precipitation event for Co over Ni is due to a combination of 1) the higher cationic charge density of the Co Werner complex (3+ versus 2+), and 2) more acidic N—H bonds in the ammonia ligands due to stronger Co—NH₃ bonding.

### Demonstration of a Co/Ni Separation Using Pre-Synthesized Werner Complexes

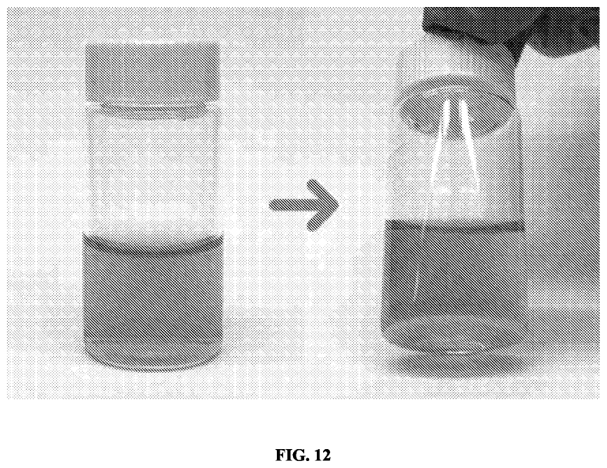

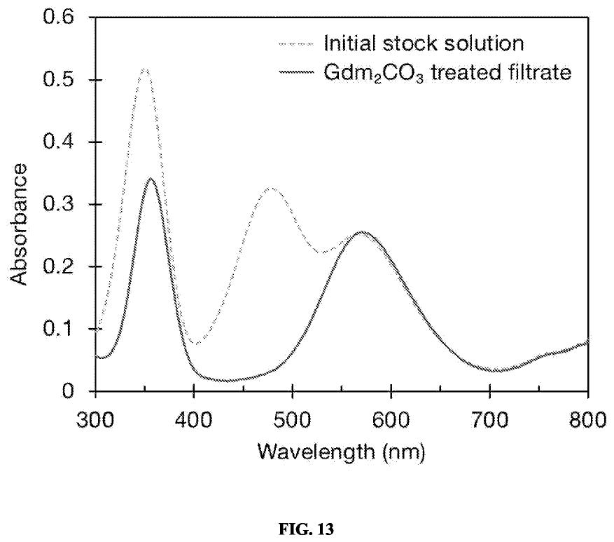

The separation of [Co(NH₃)₆][Cl]₃ from [Ni(NH₃)₆][Cl]₂ via carbonate-induced precipitation was demonstrated through treatment of a mixture of the complexes with either sodium carbonate or guanidinium carbonate. A 1:10 molar ratio of Co:Ni was chosen to mimic the nickel-rich environments commonly found in nickel laterite ores and in Li-ion battery cathodes. A dark magenta solution containing 5 mM [Co(NH₃)₆][Cl]₃ and 50 mM [Ni(NH₃)₆][Cl]₂ in aqueous NH₃ was prepared and treated with 3 equivalents of either Na₂CO₃ or Gdm₂CO₃, a yellow-orange solid was observed to quickly precipitate upon stirring, leaving behind a bright violet solution (FIG. 11 and FIG. 12). UV-Vis spectra of the mother liquor before and after carbonate addition indicated the bleaching of the spectral feature associated with [Co(NH₃)₆][Cl]₃ (λ=476 nm), while spectral features associated with [Ni(NH₃)₆][Cl]₂ (λ=571 nm) were left unchanged (FIG. 3 for Na₂CO₃, FIG. 13 for Gdm₂CO₃).

To gain more quantitative insight into the efficiency of this separation strategy, the Co and Ni contents of the two phases were evaluated via inductively coupled plasma optical emission spectroscopy (ICP-OES). In these experiments, performed in triplicate, the ammoniacal solution containing the 1:10 ratio of Werner complexes was treated with 3 equivalents of Na₂CO₃, and the resulting slurry was filtered through medium porosity frit. The precipitate was washed with aqueous NH₃, and the washing was combined with the filtrate before analyzing the two phases for their metal content. As shown in Tables 5A and 5B, large separations factors (β_{Co/Ni}) were consistently observed for this procedure (β_{Co/Ni}=19,700±1,200), with the precipitates recovering 76(10)% of Co with high purity (99.0(3))%) and the filtrates containing pure samples of Ni (99.4(2)% purity and 95(14)% recovery). These separation factors are highly competitive with state-of-the-art Co/Ni separations and showcase the significant potential of this system towards application in industrial Co/Ni separations.

TABLE 5A
ICP-OES Analysis of Co/Ni Separation (3 equivalents Na₂CO₃)

| | | Precipitate | | | Filtrate | | | |
|---|---|---|---|---|---|---|---|---|
| | | | % Co | % Co | | | % Co | % Co |
| Starting Materials | Trial | EF_{Co} | Recovery | Purity | Trial | EF_{Co} | Recovery | Purity |
| [Co(NH₃)₆][Cl]₃ | 1 | 78 | 64 | 98.7 | 236 | 79 | 99.6 | 18,496 |
| and | 2 | 106 | 81 | 99.1 | 197 | 105 | 99.5 | 20,802 |
| [Ni(NH₃)₆][Cl]₂ | 3 | 149 | 82 | 99.3 | 133 | 100 | 99.3 | 19,816 |
| | Average | 111 | 76 | 99.0 | 189 | 95 | 99.4 | 19,700 |
| | Standard | 36 | 10 | 0.3 | 52 | 14 | 0.2 | 1,200 |
| | Deviation | | | | | | | |

TABLE 5B
ICP-OES Analysis of Co/Ni Separation (3 equivalents Na₂CO₃)

| | | Precipitate | | | Filtrate | | | |
|---|---|---|---|---|---|---|---|---|
| | | | % Co | % Co | | | % Co | % Co |
| Starting Materials | Trial | EF_{Co} | Recovery | Purity | Trial | EF_{Co} | Recovery | Purity |
| CoCl₂ · 6H₂O | 1 | 148 | 85.8 | 99.3 | 61 | 103.1 | 98.3 | 9,085 |
| and | 2 | 114 | 77.8 | 99.1 | 66 | 102.1 | 98.5 | 7,577 |
| NiCl₂ · 6H₂O | 3 | 599 | 69.5 | 99.8 | 43 | 99.1 | 97.7 | 25,751 |
| | Average | 287 | 77.7 | 99.4 | 57 | 101.4 | 98.2 | 14,000 |
| | Standard | 271 | 8.2 | 0.3 | 12 | 2.8 | 0.4 | 10,000 |
| | Deviation | | | | | | | |

Co/Ni Separation from Simple Salt Mixtures

The separation of pre-synthesized Co/Ni Werner complexes (vide supra) represents a promising alternative to currently adopted Co/Ni separations methods. However, a major challenge to making this process industrially applicable lies in starting from simpler Co/Ni mixtures. In a more realistic situation, the starting Co/Ni mixture would consist of simple salts of whatever leachate the ions are dissolved in, rather than mixtures of pre-synthesized and pre-purified Co/Ni Werner complexes. Additionally, in the absence of strong L-type ligands, both metals would be expected to be divalent in aqueous media. A more applied approach towards Co/Ni separation was therefore investigated, wherein mixtures of Co/Ni chloride salts were used to better simulate the dissolved metal ions in common leaching liquors (FIG. 2). As such, a 1:10 molar mixture of CoCl₂·6H₂O and NiCl₂·6H₂O was converted to [Co^{III}(NH₃)₆][Cl]₃ and [Ni^{II}(NH₃)₆][Cl]₂ in situ in the presence of aqueous NH₃, NH₄Cl, activated charcoal, and an oxidant (H₂O₂ or air). Spectral features in UV-Vis spectra of the reaction mixture matched those of the bonafide [Co(NH₃)₆][Cl]₃ and [Ni(NH₃)₆][Cl]₂ complexes (FIG. 14). Violet crystals were obtained from the mixture when left at room temperature overnight, which were identified as [Ni(NH₃)₆][Cl]₂ via single crystal X-ray crystallography.

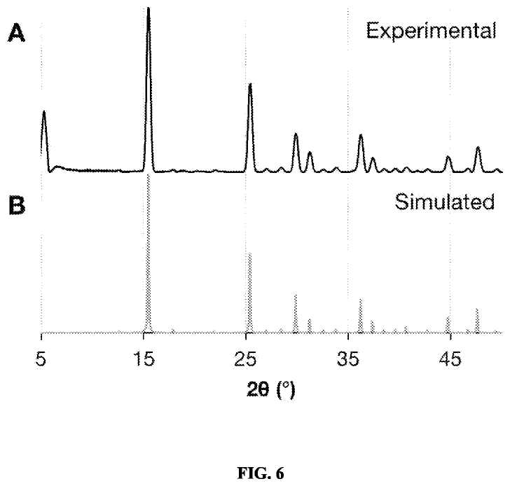

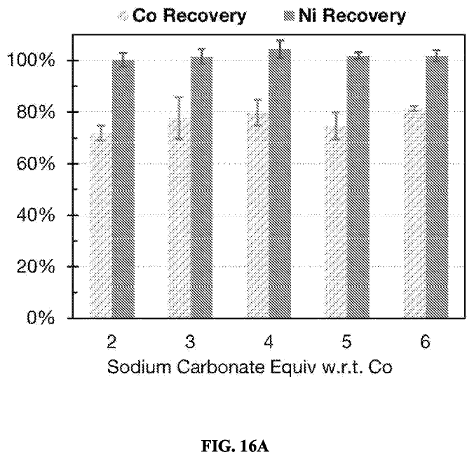

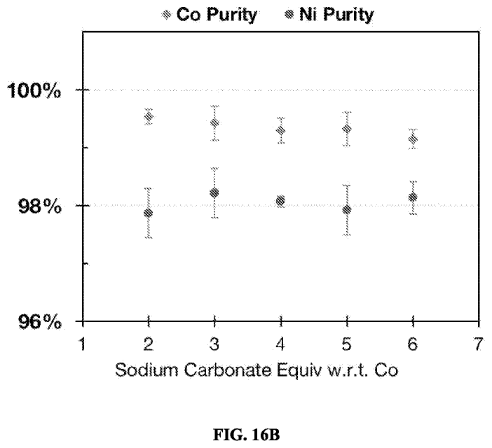

Following the formation of the mixture, additional concentrated NH_{3(aq)} and Na₂CO₃ (3 equivalents) was added to selectively afford a yellow-orange precipitate, presumably [Co(NH₃)₆][CO₃][Cl], upon stirring at r.t. for 20 min (FIG. 15). Importantly, the addition of excess NH_{3(aq)} was necessary to stimulate precipitation, and to prevent partial redissolving of the precipitate over time. Powder X-ray diffraction (PXRD) was performed on the precipitate, and the resulting diffraction pattern displayed sharp diffraction peaks that closely matched those predicted from the solid-state structure of [Co(NH₃)₆][CO₃][Cl] (FIG. 6), thereby implying that the bulk precipitate consists of this molecular solid. Thermogravimetric analysis (TGA) of the bulk precipitate material was performed yielded results that are consistent with the formula of molecular solid. The precipitate began to undergo mass loss at 200° C., at which ca. 40 wt % of the original mass was lost likely due to the loss of NH₃ ligands. Finally, the applicability of the method at low concentrations of Co and Ni in starting materials was investigated: precipitation of cobalt (0.038 g, 49.5% relative to theoretical yield) was observed at concentrations as low as 3 mM (295 ppm) of CoCl₂·6H₂O in the starting mixture.

As before, the reaction was also characterized using UV-Vis spectroscopy. Following precipitation of the orange-yellow solid, the remaining blue-violet filtrate displayed a prominent spectral feature at 571 nm, corresponding to [Ni(NH₃)₆][Cl]₂. Additionally, the feature at 476 nm, corresponding to [Co(NH₃)₆][Cl]₃, was observed to bleach following the carbonated-induced precipitation event (FIG. 2). Triplicated experiments were analyzed by ICP-OES, and they yielded comparable results to the previous separations starting from pre-synthesized Werner complexes (Table 5), suggesting the viability of a one-pot strategy where the Werner complexes can be generated in situ followed by the carbonate precipitation. Increasing and decreasing the quantity of carbonate did not have a significant effect on the metal recoveries and purities (FIGS. 19A and 19B), indicating that only minimal carbonate is necessary to impart the desired separation. The purities and recoveries of Co and Ni from these separations experiments are remarkably high and further showcase the real-world applications of this system to industrial Co/Ni separations.

### Example 6—Separation of Nickel and Cobalt Using Phosphates

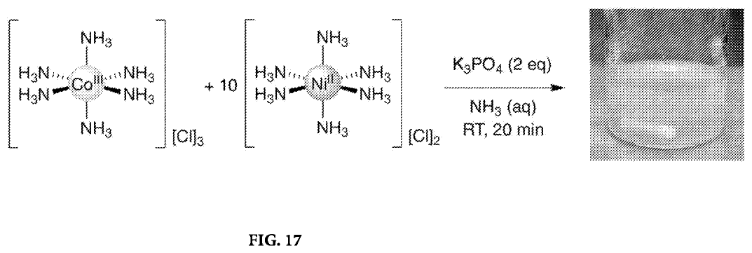

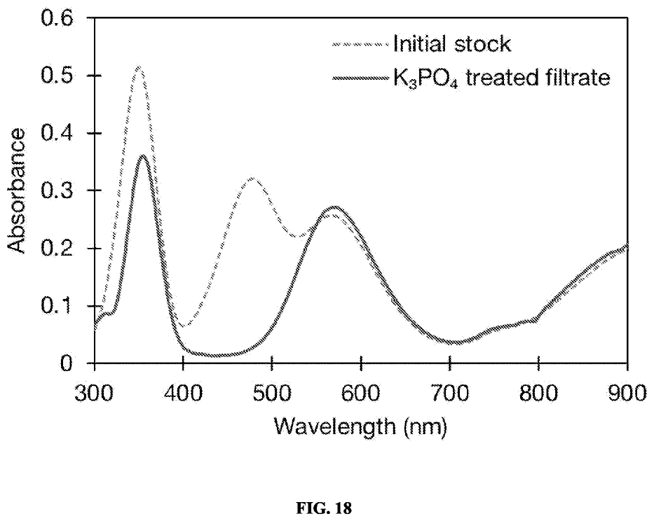

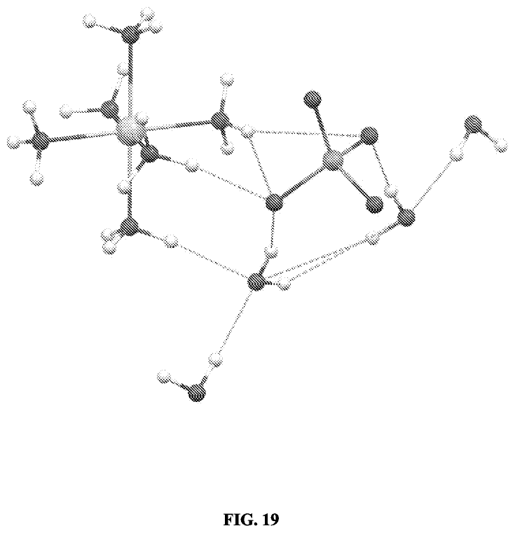

An overall scheme for selective precipitation of cobalt using phosphate is shown in FIG. 17.

CoCl₂·6H₂O (0.333 g, 1.40 mmol, 1.1 equivalents), NiCl₂·6H₂O (3.302 g, 13.9 mmol, 11 equivalents) were dissolved in 5 mL of deionized water. The mixture was sonicated until the metal salts dissolved completely to form a dark green solution. An aliquot of the solution (9.26 wt %≈ 1/11) was removed for subsequent ICP analysis as starting mixture. To the remaining solution was added NH₄Cl (2.024 g, 37.8 mmol, 30 equivalents) and activated charcoal (0.167 g, 13.9 mmol, 11 equivalents), followed by dropwise addition of 20 mL of aqueous NH₃ which led to an immediate color change to violet. The mixture was then subjected to oxidation via one of the two methods below.

Method A: Using H₂O₂

In an ice bath, to the flask was slowly added 15 mL of cold 30% H₂O₂ dropwise over ca. 2 min with stirring (200 rpm). An exothermic reaction with effervescence immediately occurred. The mixture was stirred (200 rpm) at 0° C. for 20 min and then at room temperature for 20 min.

### Method B: Using Aeration

To compensate for the loss of ammonia during aeration, air was bubbled through a side-arm flask containing aqueous ammonia before being passed into the reaction mixture using a glass pipette for 3 h.

Following oxidation, the mixture was then heated to 60° C. in a water bath with stirring for 20 min, and the charcoal was removed by filtering the hot solution over a Buchner funnel. The filtered charcoal was washed with 3×5 mL of aqueous NH₃ which was combined with dark magenta filtrate. UV-Vis: λ=476 nm ([Co(NH₃)₆][Cl]₃), λ=571 nm ([Ni(NH₃)₆][Cl]₂).

Upon addition of K₃PO₄ (following Method A: 0.536 g, 2.53 mmol, 2 equivalents) to the dark magenta filtrate, orange precipitate immediately formed. The mixture was stirred at 500 rpm for 15 min at room temperature. The solid was collected by filtering the slurry over a medium porosity fritted funnel and was thoroughly washed with 3×10 mL of aqueous NH₃ and 10 mL of water. It should be noted that the medium porosity frit was not able to capture all solid materials, as indicated by the cloudiness of the filtrate. The precipitate was dried overnight at 40° C. in an electric oven before being removed from the funnel. Portions of the precipitate and aliquots of the remaining violet filtrate were taken for subsequent ICP-OES analysis.

### Preparation of ICP Samples

Aqueous aliquots of the filtrate were dried under vacuum prior to next steps. All samples were heated at 300° C. using a sand bath for 30 min and allowed to cool to room temperature. Finally, samples were digested in 5 mL of concentrated HCl at room temperature overnight, followed by dilution with ultra-pure water. From ICP analysis: Co yield: 62.8%, Co purity: >99.99%; Ni yield: 102%, Ni purity: 96.9%.

### ICP-OES Analysis of Replicate Experiments

Table 6 summarizes the results obtained from triplicated experiments using Method A and duplicated experiments using Method B.

TABLE 6
ICP-OES Analysis of Replicate Experiments

| Oxidation Method | Product | Recovery | Purity |
|---|---|---|---|
| Method A: H₂O₂ | Co (precipitate) | 51(10)% | >99.9% |
| | Ni (filtrate) | 101.7(8)% | 95.9(9)% |
| Method B: aeration | Co (precipitate) | 65(5)% | >99.9% |
| | Ni (filtrate) | 99(3)% | 97.4(6)% |

### UV-Vis Analysis of Co/Ni Separation Using Pre-Synthesized Werner Complexes

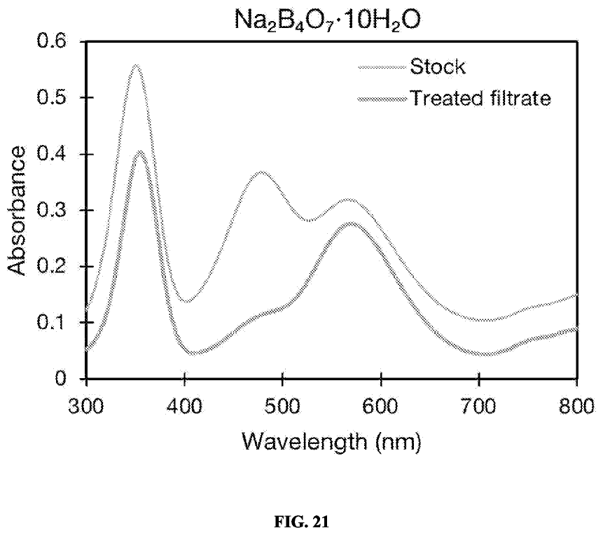

A solution containing 5 mM [Co(NH₃)₆][Cl]₃ (0.0337 g, 0.126 mmol, 1 equivalent) and 50 mM [Ni(NH₃)₆][Cl]₂ (0.2898 g, 1.25 mmol, 10 equivalents) was prepared in 25.0 mL of aqueous ammonia. An aliquot (6.0 mL) of the ammoniacal mixture was taken out and added K₃PO₄ (0.0222 g, 0.105 mmol, 3 equivalents). Pale orange precipitate formed immediately, and the mixture was stirred (500 rpm) at room temperature for 15 min. Samples of the initial ammoniacal mixture and the filtered mixture after the K₃PO₄ addition were analyzed by UV-Vis spectroscopy (FIG. 21).

### Synthesis of [Co(NH₃)₆][PO₄]·4H₂O

Crystalline samples of [Co(NH₃)₆][PO₄]·4H₂O of single crystal quality were prepared by adding K₃PO₄ (0.0192 g, 0.090 mmol) to a pale orange solution of [Co(NH₃)₆][Cl]₃ (0.0113 g, 0.042 mmol) in 10 mL water in a scintillation vial. The capped vial was left under ambient conditions. Large acicular orange crystals formed overnight.

X-ray intensity data were collected on a Rigaku XtaLAB Synergy-S diffractometer equipped with an HPC area detector (HyPix-6000HE) and employing confocal multilayer optic-monochromated Cu-Kα radiation (λ=1.54184 k) at a temperature of 100K (FIG. 19).

### Example 7—Separation of Nickel and Cobalt Using Borates

An overall scheme for selective precipitation of cobalt using borate is similar to that shown in FIG. 17 for phosphates, except that borate salts are used in this Example instead of phosphate salts.

A stock solution containing 5 mM [Co(NH₃)₆][Cl]₃ and 50 mM [Ni(NH₃)₆][Cl]₂ in aqueous ammonia was prepared in a 250 mL volumetric flask. To each scintillation vial was added 10 mL of the stock solution and borate salt (ca. 2 equivalents with respect to Co, 0.1 mmol). A stir bar was used to stir the solution under ambient conditions for 20 minutes at 500 rpm. Upon stirring, samples in which precipitation took place were selected for further analysis based on visual inspection, whereas samples with no change in appearance were capped and set aside. The supernatant of those selected samples was filtered, and the filtrate was analyzed by UV-Vis spectroscopy. Precipitate was observed for sodium perborate tetrahydrate (NaBO₃·4H₂O) upon sitting after 4 days.

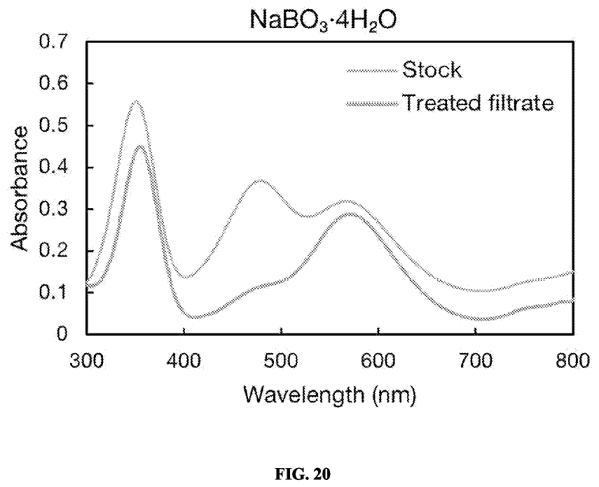

For addition of sodium perborate tetrahydrate, (NaBO₃·4H₂O), the UV-Vis spectra are shown in FIG. 20.

For addition of borax, Na₂B₄O₇·10H₂O, the UV-Vis spectra are shown in FIG. 21.

### Example 8—Separation of Nickel and Cobalt Using Sulfates

An overall scheme for selective precipitation of cobalt using sulfate is similar to that shown in FIG. 17 for phosphates, except that sulfate salts are used in this Example instead of phosphate salts.

A stock solution containing 5 mM [Co(NH₃)₆][Cl]₃ and 50 mM [Ni(NH₃)₆][Cl]₂ in aqueous ammonia was prepared in a 250 mL volumetric flask. To each scintillation vial was added 10 mL of the stock solution and sulfate salt (ca. 2 equivalents with respect to Co, 0.1 mmol). A stir bar was used to stir the solution under ambient conditions for 20 minutes at 500 rpm. Upon stirring, samples in which precipitation took place were selected for further analysis based on visual inspection, whereas samples with no change in appearance were capped and set aside. The supernatant of those selected samples was filtered, and the filtrate was analyzed by UV-Vis spectroscopy.

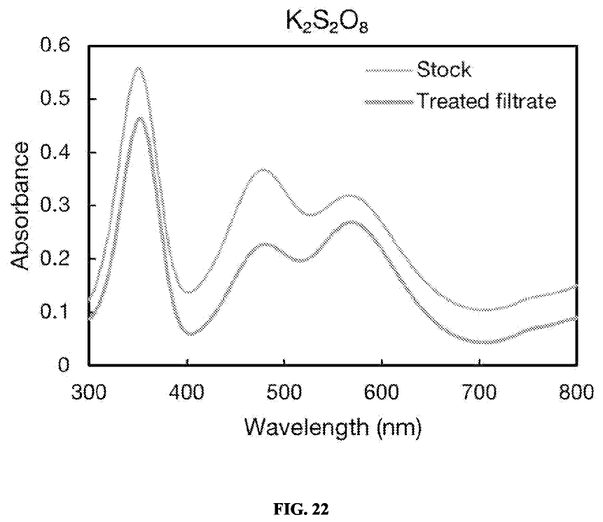

For addition of potassium persulfate, K₂S₂O₈, the UV-Vis spectra are shown in FIG. 22.

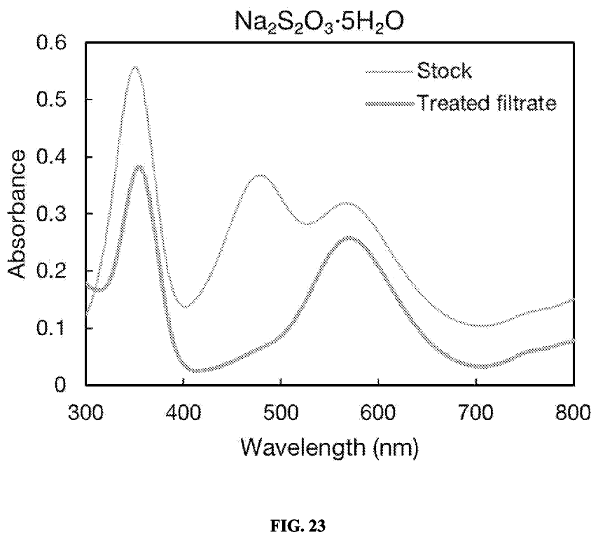

For addition of sodium thiosulfate, Na₂S₂O₃·5H₂O, the UV-Vis spectra are shown in FIG. 23.

### Example 9—Separation of Nickel and Cobalt Using Silicates

An overall scheme for selective precipitation of cobalt using silicate is similar to that shown in FIG. 17 for phosphates, except that silicate salts are used in this Example instead of phosphate salts.

A stock solution containing 5 mM [Co(NH₃)₆][Cl]₃ and 50 mM [Ni(NH₃)₆][Cl]₂ in aqueous ammonia was prepared in a 250 mL volumetric flask. To each scintillation vial was added 10 mL of the stock solution and silicate salt (ca. 2 equivalents with respect to Co, 0.1 mmol). A stir bar was used to stir the solution under ambient conditions for 20 minutes at 500 rpm. Upon stirring, samples in which precipitation took place were selected for further analysis based on visual inspection, whereas samples with no change in appearance were capped and set aside. The supernatant of those selected samples was filtered, and the filtrate was analyzed by UV-Vis spectroscopy.

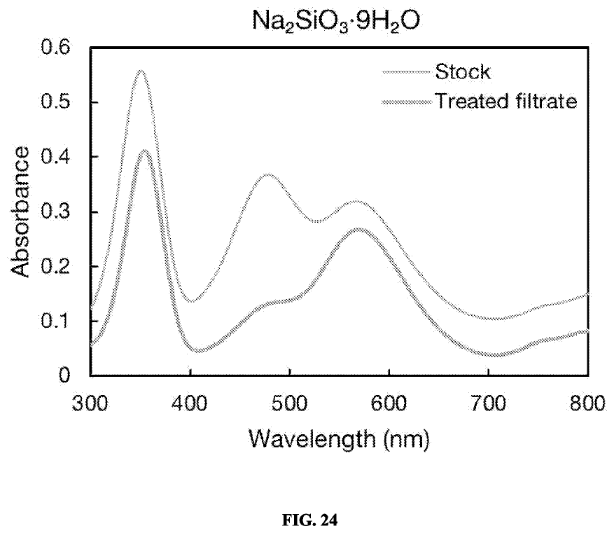

For addition of with sodium metasilicate nonahydrate, Na₂SiO₃·9H₂O, the UV-Vis spectra are shown in FIG. 24.

### Example 10—Separation of Nickel and Cobalt Using Iodates

An overall scheme for selective precipitation of cobalt using iodate is similar to that shown in FIG. 17 for phosphates, except that iodate salts are used in this Example instead of phosphate salts.

A stock solution containing 5 mM [Co(NH₃)₆][Cl]₃ and 50 mM [Ni(NH₃)₆][Cl]₂ in aqueous ammonia was prepared in a 250 mL volumetric flask. To each scintillation vial was added 10 mL of the stock solution and iodate salt (ca. 2 equivalents with respect to Co, 0.1 mmol). A stir bar was used to stir the solution under ambient conditions for 20 minutes at 500 rpm. Upon stirring, samples in which precipitation took place were selected for further analysis based on visual inspection, whereas samples with no change in appearance were capped and set aside. The supernatant of those selected samples was filtered, and the filtrate was analyzed by UV-Vis spectroscopy. Precipitate was observed for sodium metaperiodate (NaIO₄) upon sitting after 4 days.

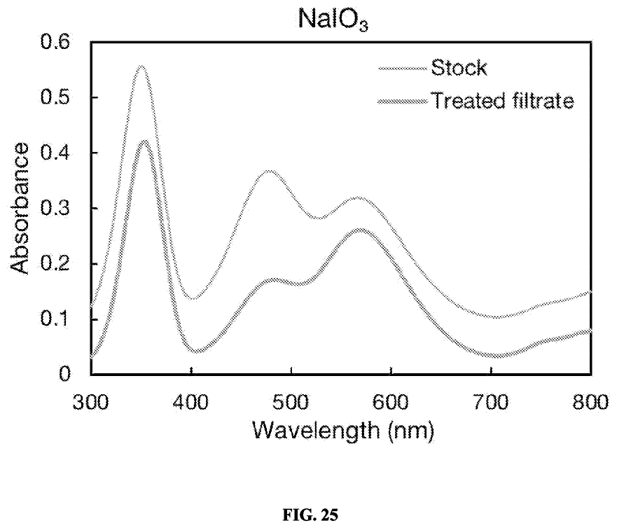

For addition of with sodium iodate, NaIO₃, the UV-Vis spectra are shown in FIG. 25.

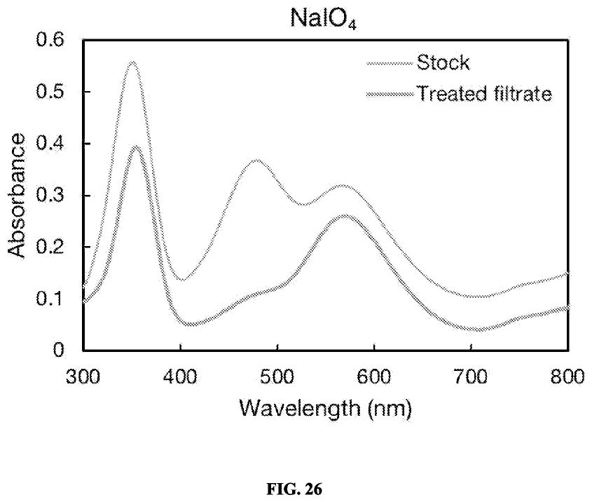

For addition of with sodium metaperiodate, NaIO₄, the UV-Vis spectra are shown in FIG. 26.

While we have described a number of embodiments of this invention, it is apparent that the basic examples may be altered to provide other embodiments that utilize the compounds and methods of this invention. Therefore, it will be appreciated that the scope of this invention is to be defined by the appended claims rather than by the specific embodiments that have been represented by way of example.

1. A method of separating cobalt and nickel, comprising:
a) mixing a solution comprising a Co^{II} complex and a Ni^{II} complex with an oxidizing agent and a compound selected from a halide, a nitrate, a chlorate, a perchlorate and combinations thereof so as to give rise to a Co^{III} complex; and
b) precipitating the Co^{III} complex by contacting the Co^{III} complex with a carbonate, a phosphate, a borate, a sulfate, a silicate or an iodate.

2. The method of claim 1, wherein the oxidizing agent is a peroxide, oxygen, or a mixture thereof.

3-8. (canceled)

9. The method of claim 1, wherein the halide is a chloride selected from sodium chloride, potassium chloride, calcium chloride, ammonium chloride and combinations thereof:
the nitrate is selected from ammonium nitrate, calcium nitrate, sodium nitrate, potassium nitrate and combinations thereof;
the chlorate is selected from ammonium chlorate, sodium chlorate, magnesium chlorate, potassium chlorate, calcium chlorate and combinations thereof; and
the perchlorate is selected from ammonium perchlorate, sodium perchlorate, potassium perchlorate and combinations thereof.

10-16. (canceled)

17. The method of claim 1, wherein the Co^{II} complex is CoCl₂*6H₂O and the Ni^{II} complex is NiCl₂*6H₂O.

18. (canceled)

19. The method of claim 1, wherein step a) further comprises mixing with ammonium chloride in aqueous ammonium hydroxide solution.

20. The method of claim 1, wherein the mixing is carried out at about 0° C. or at room temperature and the solution is then heated to about 60° C.

21-22. (canceled)

23. The method of claim 1, wherein step a) produces [Co(NH₃)₆][Cl]₃ and [Ni(NH₃)₆][Cl]₂.

24-26. (canceled)

27. The method of claim 1, wherein the carbonate is sodium carbonate, sodium bicarbonate or guanidinium carbonate:
the phosphate is sodium phosphate or potassium phosphate;
the borate is borax, Na₂B₄O₇·10H₂O, or sodium perborate Na₂([B₂O₄(OH)₄]);
the sulfate is potassium persulfate, Na₂S₂O₈ or sodium thiosulfate, Na₂S₂O₃·5H₂O;
the silicate is sodium metasilicate nonahydrate, Na₂SiO₃·9H₂O; and
the iodate is sodium iodate, NaIO₃, or sodium metaperiodate, NaIO₄.

28-43. (canceled)

44. The method of claim 1, wherein the carbonate, phosphate, borate, sulfate, silicate or iodate is included in an amount that is at least about 1 equivalent of carbonate per cobalt.

45. The method of claim 1, wherein the carbonate, phosphate, borate, sulfate, silicate or iodate is included in an amount that is at least about 2 equivalents of carbonate per cobalt.

46. The method of claim 1, wherein the carbonate, phosphate, borate, sulfate, silicate or iodate is included in an amount that is at least about 3 equivalents of carbonate per cobalt.

47. The method of claim 1, wherein the carbonate, phosphate, borate, sulfate, silicate or iodate is included in an amount that is at least about 4 equivalents of carbonate per cobalt.

48. The method of claim 1, wherein the carbonate, phosphate, borate, sulfate, silicate or iodate is included in an amount that is at least about 5 equivalents of carbonate per cobalt.

49. The method of claim 1, wherein the carbonate, phosphate, borate, sulfate, silicate or iodate is included in an amount that is at least about 6 equivalents of carbonate per cobalt.

50. The method of claim 1, wherein the carbonate, phosphate, borate, sulfate, silicate or iodate is included in an amount that is at least about 7 equivalents of carbonate per cobalt.

51. The method of claim 1, wherein the carbonate, phosphate, borate, sulfate, silicate or iodate is included in an amount that is at least about 8, 9 or 10 equivalents of carbonate per cobalt.

52-53. (canceled)

54. The method of claim 1, wherein the carbonate, phosphate, borate, sulfate, silicate or iodate is included in an amount up to about 10 equivalents of carbonate per cobalt.

55. The method of claim 1, wherein the carbonate, phosphate, borate, sulfate, silicate or iodate is comprised in an aqueous ammonium hydroxide solution.

56. The method of claim 1, wherein step b) is carried out at room temperature for about 20 minutes.

57. The method of claim 1, wherein the Co^{II} complex is a chloride salt and the Ni^{II} complex is a chloride salt.

58. (canceled)
